(19) United States
(12) Patent Application Publication
(10) Pub. No.: US 2005/0203702 A1
(43) Pub. Date: Sep. 15, 2005

(54) Method for backup dual-frequency navigation during brief periods when measurement data is unavailable on one of two frequencies

(76) Inventors: Richard T. Sharpe, Torrance, CA (US); Frederick W. Nelson, Waukee, IA (US); Terence D. Pickett, Urbandale, IA (US); Ronald R. Hatch, Wilmington, CA (US); Yunchun Yang, Harbor City, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/800,178

(22) Filed: Mar. 12, 2004

(51) Int. Cl. G01C 21/26

(52) U.S. Cl. 701/213

(57) ABSTRACT

The present invention includes a method for performing backup dual-frequency navigation during a brief period when one of two frequencies relied upon by dual-frequency navigation is unavailable. The method includes synthesizing the code and carrier-phase measurements on the unavailable frequency using the carrier-phase measurements on the retained frequency and a model of ionospheric refraction effects, which is updated when measurements on both frequencies are available.

The present invention relates generally to technologies associated with positioning and navigation using satellites, and more particularly to dual-frequency navigation using the global positioning system (GPS).

### BACKGROUND

The global positioning system (GPS) uses satellites in space to locate objects on earth. With GPS, signals from the satellites arrive at a GPS receiver and are used to determine the position of the GPS receiver. Currently, two types of GPS measurements corresponding to each correlator channel with a locked GPS satellite signal are available for civilian GPS receivers. The two types of GPS measurements are pseudorange, and integrated carrier phase for two carrier signals, L1 and L2, with frequencies of 1.5754 GHz and 1.2276 GHz, or wavelengths of 0.1903 m and 0.2442 m, respectively. The pseudorange measurement (or code measurement) is a basic GPS observable that all types of GPS receivers can make. It utilizes the C/A or P codes modulated onto the carrier signals. The measurement records the apparent time taken for the relevant code to travel from the satellite to the receiver, i.e., the time the signal arrives at the receiver according to the receiver clock minus the time the signal left the satellite according to the satellite clock.

The carrier phase measurement is obtained by integrating a reconstructed carrier of the signal as it arrives at the receiver. Thus, the carrier phase measurement is also a measure of a transit time difference as determined by the time the signal left the satellite according to the satellite clock and the time it arrives at the receiver according to the receiver clock. However, because an initial number of whole cycles in transit between the satellite and the receiver when the receiver starts tracking the carrier phase of the signal is usually not known, the transit time difference may be in error by multiple carrier cycles, i.e., there is a whole-cycle ambiguity in the carrier phase measurement.

With the GPS measurements available, the range or distance between a GPS receiver and each of a multitude of satellites is calculated by multiplying a signal's travel time by the speed of light. These ranges are usually referred to as pseudoranges (false ranges) because the receiver clock generally has a significant time error, which causes a common bias in the measured range. In addition, several error factors exist that can lead to errors or noise in the calculated range, such as the ephemeris error, satellite clock timing error, atmospheric effects, receiver noise and multipath error. The common bias from receiver clock error is usually solved for along with the position coordinates of the receiver as part of the normal navigation computation.

With standalone GPS navigation, where a user with a GPS receiver obtains code and/or carrier-phase ranges with respect to a plurality of satellites in view, without consulting with any reference station, the user is very limited in ways to reduce the errors or noises in the ranges. To eliminate or reduce some of these errors, differential techniques are typically used in GPS applications. Differential GPS (DGPS) operations typically involve one or more reference GPS receivers in fixed locations, a user (or navigation) GPS receiver, and communication links among the user and reference receivers. The reference receivers are used to generate corrections associated with some or all of the above error factors. The corrections are supplied to the user receiver and the user receiver then uses the corrections to appropriately correct its computed position.

A number of different techniques have been developed to obtain high-accuracy differential navigation using the GPS carrier-phase measurements. The highest accuracy technique is generally referred to as “real-time kinematic” (RTK) and has a typical accuracy of about one-centimeter. However, in order to obtain that accuracy, the whole-cycle ambiguity in the differential carrier-phase measurements must be determined. When the reference receiver is a substantial distance (more than a few tens of kilometers) from the navigation receiver it may become impossible to determine the whole-cycle ambiguity and the normal RTK accuracy cannot be achieved. Under these adverse circumstances the best that can be done is often to estimate the whole-cycle ambiguities as a real-valued (non-integer) variable. This practice is often referred to as determining a “floating ambiguity” value.

One method for determining the “floating ambiguity” value is to form refraction corrected code and carrier-phase measurements, scale the refraction corrected carrier-phase measurement to the same unit as the refraction corrected code measurement, and form an offset by subtracting the refraction corrected carrier-phase measurement from the refraction-corrected code measurement. This offset value can be recursively averaged over time so that it becomes an increasingly accurate estimate of the “floating ambiguity.” Exactly the same net result can be obtained by smoothing a code measurement with a linear combination of the corresponding L1 and L2 carrier-phase measurements that is formed to match the ionospheric refraction effect of the code measurement.

Several types of differential GPS systems that provide measurements or measurement corrections to navigation receivers are currently available. Among them, the High Accuracy Nationwide Differential GPS System (HA-ND GPS), which is developed cooperatively by several U.S. government organizations, uses ground based reference sites. This system transmits the corrections to the user using Coast Guard beacons that can reach users at ranges of a few hundred kilometers. John Deere has developed the StarFire™ system, which transmits corrections via communication satellites with both a regional wide area correction data stream and a global DGPS correction data stream. In these systems, navigation results in the 10 centimeter range can be obtained after the carrier-phase floating ambiguities have been determined with sufficient accuracy, that is, after sufficient time has elapsed since the navigation receiver starts tracking the satellite signals.

One of the principal problems of these navigation systems is that anything such as interfering signals, shading or signal blockage, etc., which causes one of the signals from any of the satellites to be temporarily lost, will cause “cycle slips” in the carrier-phase measurements and the floating ambiguity value will no longer be correct. In the current commercial environment, the L2 signals are much more apt to be lost than the L1 measurements. There are several reasons for this. First the broadcast L1 signal is stronger than the broadcast L2 signal. In addition, commercial access to the L2 signal requires a “codeless” or “semi-codeless” technique to be employed to avoid the selective availability imposed on the L2 signal by the military. As a result, only a small amount of interference or signal blockage can cause a loss of the L2 measurements. Without some means of reinitializing the floating ambiguity value, a long time interval will be required to determine anew the correct floating ambiguity value after the L2 signal returns. Therefore there is a need for a technique to reinitialize the floating ambiguity value after a brief L2 signal outage so that the long initialization process can be avoided.

### SUMMARY

The present invention includes a method for performing backup dual-frequency navigation whereby the L2 code and carrier-phase measurements are synthesized using a combination of the retained L1 carrier-phase measurements and a model of the ionospheric refraction effects, which is updated when measurements on both the L1 and L2 frequencies are available. As an optional process, a divergence between the retained code and carrier phase measurements can be used to detect slowly changing deviations from the ionospheric refraction model. This allows an increase in the interval over which synthesized measurements can be successfully generated.

In one embodiment of the present invention, the backup dual-frequency navigation is performed for each satellite from which the L2 measurements are lost for a time period at the user GPS receiver, and the method for performing the backup dual-frequency navigation includes steady-state processing when measurements on both the L1 and L2 frequencies from the satellite are available. During the steady-state processing, smoothed code measurements and smoothed offsets between code and carrier-phase measurements are computed. Also, corrections to an ionospheric model are generated. Thereafter, when direct measurements on the L2 frequency from the satellite are unavailable, backup operations are performed for each measurement epoch until the L2 signals are detected again at the user GPS receiver. During the backup operations, the ionospheric model corrections are used to generate estimated L2 carrier-phase measurements, which are used to generate estimated code measurements on both the L1 and the L2 frequencies. The estimated and measured code measurements on the L1 frequency are used in an optional step in which ionospheric model corrections are updated. Upon the return of the L2 signals, a transition to dual frequency navigation using both the L1 and L2 signals from the satellite is performed.

Thus, the method in one embodiment of the present invention allows dual frequency operation at a GPS receiver to continue in the situation when signals from one or more satellites on one of the frequencies become unavailable for a time period.

### DRAWINGS

FIG. 1 is a block diagram of a computer system that can be used to perform the backup dual frequency navigation method according to one embodiment of the present invention.

FIG. 2 is a flowchart illustrating the method for backup dual frequency navigation according to one embodiment of the present invention.

FIG. 3 is a flowchart illustrating a step for generating smoothed code measurements and smoothed offsets between the code and carrier-phase measurements during steady state processing in the method for backup dual-frequency navigation.

FIG. 4 is a flowchart illustrating a step for generating ionospheric model corrections during steady state processing in the method for backup dual frequency navigation.

FIG. 5 is a flowchart illustrating a step for generating synthesized (or estimated) L2 carrier-phase measurement in the method for backup dual-frequency navigation when direct L2 measurements are unavailable.

FIG. 6 is a flowchart illustrating a step for generating synthesized code measurement in the method for backup dual-frequency navigation when L2 measurements are unavailable.

FIG. 7 is a flowchart illustrating an optional step for updating the ionospheric model corrections in the method for backup dual frequency navigation when L2 measurements are unavailable.

FIG. 8 is a flowchart illustrating a transition to steady-state dual-frequency navigation after the L2 signal returns.

### DESCRIPTION

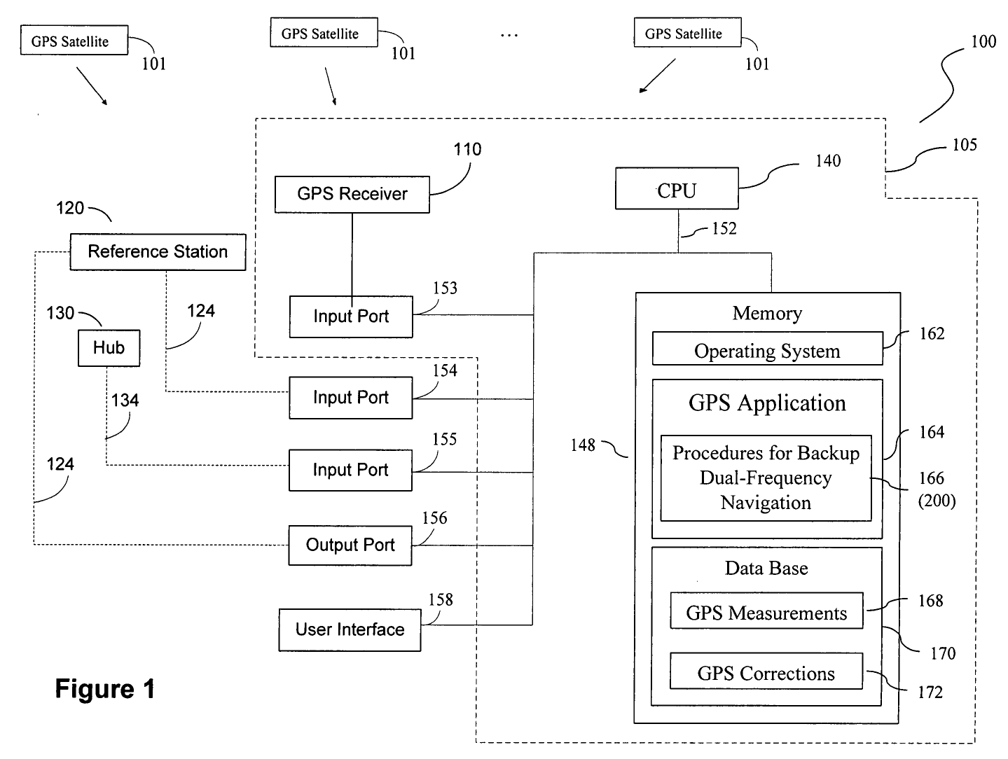

FIG. 1 illustrates a system 100 for performing backup dual-frequency navigation in case of an occasional loss-of-lock on the L2 signal from one of the satellites, according to one embodiment of the present invention. As shown in FIG. 1, system 100 can be a microprocessor-based computer system 100 coupled to a GPS receiver 110, which provides raw GPS observables to system 100 for processing. These observables include GPS code and carrier phase measurements, ephemerides, and other information obtained according to signals received from a plurality of satellites 101.

To facilitate differential operations, system 100 may also be coupled to a reference station 120 via a radio link 124. The reference station 120 provides GPS observables measured thereat and/or GPS corrections calculated thereat. In wide-area or global applications, system 100 may be coupled to one or more central hubs 130 in communication with a group of reference stations (not shown) via radio and/or satellite links 134. The hub(s) 130 receives GPS observables from the group of reference stations and computes corrections that are communicated to the system 100.

In one embodiment of the present invention, system 100 includes a central processing unit (CPU) 140, a memory device 148, a plurality of input ports 153, 154, and 155, one or more output ports 156, and an optional user interface 158, interconnected by one or more communication buses 152. Memory 148 may include high-speed random access memory and may include nonvolatile mass storage, such as one or more magnetic disk storage devices. Memory 148 may also include mass storage that is remotely located from the central processing unit 140. Memory 148 preferably stores an operating system 162, a database 170, and GPS application programs or procedures 164, including procedures for backup dual frequency navigation 166 according to one embodiment of the present invention. The operating system 162 and application programs and procedures 164 stored in memory 148 are for execution by the CPU 140 of the computer system 100. Memory 148 preferably also stores data structures used during the execution of the GPS application procedures 166, such as GPS measurements and corrections, as well as other data structures discussed in this document.

The input ports 154 are for receiving data from the GPS receiver 110, the reference station 120, and/or the hub 130, respectively, and the output port(s) 156 can be used for outputting calculation results. Alternately, calculation results may be shown on a display device of the user interface 158.

The operating system 162 may be, but is not limited to, the embedded operating system, UNIX, Solaris, or Windows 95, 98, NT 4.0, 2000 or XP. More generally, operating system 162 has procedures and instructions for communicating, processing, accessing, storing and searching data.

As indicated by the dashed line 105 in FIG. 1, in some embodiments, the GPS receiver 110 and part or all of the computer system 100 are integrated into a single device, within a single housing, such as a portable, handheld or even wearable position tracking device, or a vehicle-mounted or otherwise mobile positioning and/or navigation system. In other embodiments, the GPS receiver 110 and the computer system 100 are not integrated into a single device.

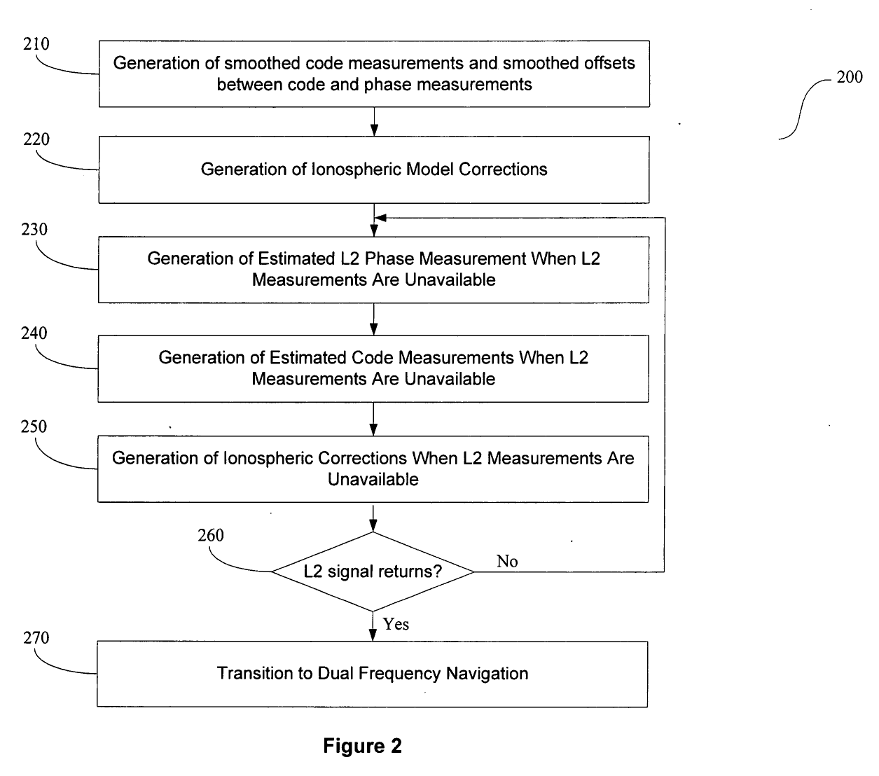

FIG. 2 is a flowchart illustrating a process 200 for performing backup dual-frequency navigation according to one embodiment of the present invention. The process 200 is performed for each satellite 101 from which the L2 measurements are lost for a time period at the GPS receiver 110. As shown in FIG. 2, process 200 includes steps 210 and 220, which are performed during steady-state processing when measurements on both the L1 and L2 frequencies from the satellite are available. In step 210, smoothed code measurements and smoothed offsets between code and carrier-phase measurements are computed. In step 220, ionospheric model corrections are generated. Thereafter, when direct measurement on L2 frequency from the satellite becomes unavailable, steps 230, 240, and optional step 250 are performed for each measurement epoch before the L2 signals returns at the GPS receiver 110. In step 230, the ionospheric model corrections are used to generate estimated L2 carrier-phase measurements, which are used in the subsequent step 240 to generate estimated code measurements on both L1 and L2 frequencies. The estimated and measured code measurements on the L1 frequency are used in the subsequent optional step 250 in which ionospheric model corrections are updated. The process 200 then proceeds to a step 260 in which it is determined whether L2 signals from the satellite have returned. If L2 signals have not returned, steps 230 through 250 are repeated for the next measurement epoch using the updated ionospheric model corrections. Otherwise, upon the return of L2 signals, a transition to dual frequency navigation using both L1 and L2 signals from the satellite is performed in step 270.

During steady-state processing when measurements from both L1 and L2 frequencies are available, the multipath error in each code measurement can be minimized by forming a combination of the L1 and L2 carrier-phase measurements that matches the ionospheric refraction effect in the code measurement, and by smoothing the code measurement with the carrier-phase measurement combination. Many receivers make both a C/A-code measurement and a P-code measurement on the L1 frequency. Either of the C/A or P-code measurement can be used as the L1 code measurement. However, whichever of the two is chosen, the same should be used at the user and the reference station(s) since small biases exist between the two measurements. In the discussion that follows, the L1 frequency (equal to about 1.57542 GHz) is designated as f₁ and the L2 frequency (normally equal to about 1.2276 GHz) is designated as f₂. The pseudorange code measurement (whether C/A or P) on the L1 frequency is designated as P₁ and the pseudorange code measurement on the L2 frequency is designated as P₂. The L1 carrier-phase measurement in meters will be designated simply as L₁ and the L2 carrier-phase measurement in meters will be designated as L₂. The carrier-phase measurements are scaled by the wavelengths and an approximate whole-cycle ambiguity value is added to each so that the phase measurements are made close to the same value as the corresponding code measurement. Thus, using φ₁ to designate the raw phase measurement in cycles at the f₁ frequency and φ₂ to designate the raw phase measurement in cycles at the f₂ frequency, we have the following relationships:
L₁=(φ₁+N₁⁰)λ₁ (1)
L₂=(φ₂+N₂⁰)λ₂ (2)

The wavelength λ₁ for the L1 frequency is approximately equal to 0.1903 meters and the wavelength of λ₂ for the L2 frequency is approximately 0.2442 meters. The approximate whole-cycle values of, N₁⁰ and N₂⁰ are added at the start of carrier-phase tracking to give values that are within one wavelength of the corresponding code measurements simply to keep the differences to be formed subsequently small.

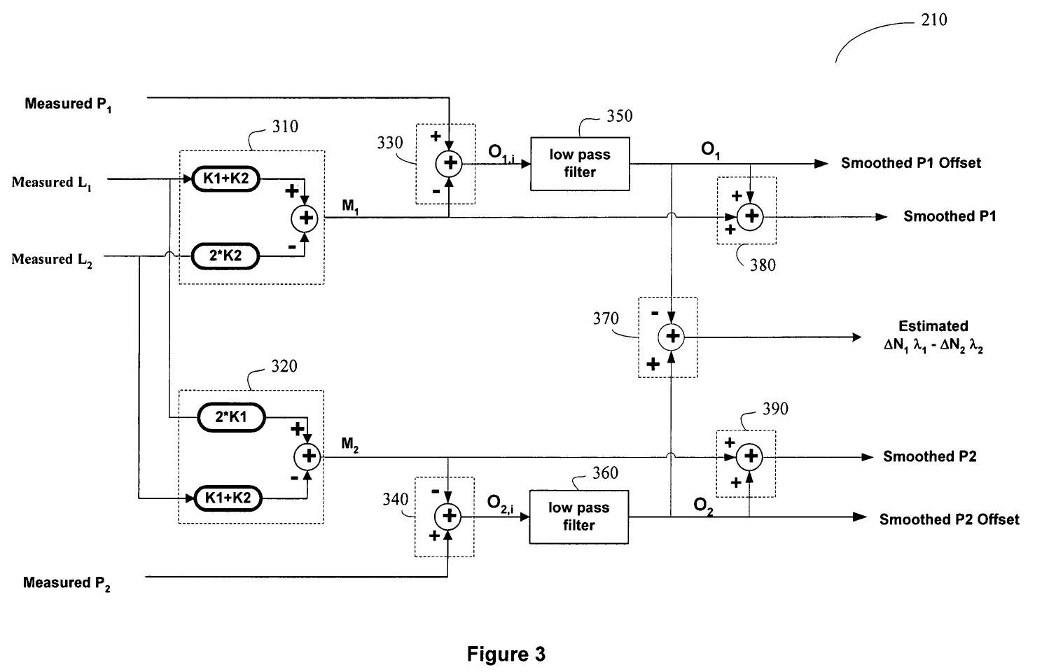

FIG. 3 is a flowchart illustrating in more detail step 210 in process 200, in which smoothed code measurements and smoothed offsets between the code measurements and corresponding carrier-phase measurements are computed during steady-state processing when signals on both L1 and L2 frequencies are available from the satellite. When the L2 signal is not available, the previously computed values for the smoothed P1 offset (O₁), smoothed P2 offset (O₂) and the estimated ΔN₁λ₁−ΔN₂λ₂ (O₂−O₁) from the last epoch of steady-state processing are stored and used during backup dual frequency operation.

As shown in FIG. 3, step 210 includes a substep 310, in which a first linear combination M₁ of L₁ and L₂ are formed to match the delay due to the ionospheric refraction effect on code measurement P₁, and a substep 320, in which a second linear combination M₂ of L₁ and L₂ are formed to match the delay due to the ionospheric refraction effect on code measurement P₂. Substeps 310 and 320 are performed according to the following equations:
M₁=(K₁+K₂)L₁−2K₂L₂ (3)
M₂=2K₁L₁−(K₁+K₂)L₂ (4)
where K₁ and K₂ are coefficients defined as follows:

$$\begin{matrix}{K}_{1} = \frac{{f}_{1}^{2}}{{f}_{1}^{2} - {f}_{2}^{2}} ≅ 2.5457 & ( 5 ) \\ {K}_{2} = \frac{{f}_{2}^{2}}{{f}_{1}^{2} - {f}_{2}^{2}} ≅ 1.5457 & ( 6 )\end{matrix}$$

Because the ionospheric effects on the code measurements P₁ and P₂ have been matched by the respective linear combinations M₁ and M₂ of the carrier-phase measurements, and because all clock variations and motions for either the satellite transmitter or the user receiver have identical effects on the code and carrier-phase measurements, M₁ and P₁, or M₂ and P₂, should be identical except for possible whole-cycle ambiguity errors in the carrier-phase combination, M₁ or M₂, and the higher multipath noise in the code measurement P₁ or P₂, respectively. This allows the formation of smoothed code measurements which approaches the small measurement noise of the carrier-phase measurements but without the associated whole-cycle ambiguity.

Thus, step 210 further includes a substep 330, in which an offset between P₁ and M₁ is computed, and a substep 350, in which the offset is processed in a low pass filter to form a smoothed offset O₁ between P₁ and M₁ (referred in FIG. 3 and subsequently as the “smoothed P₁ offset”). In parallel, step 210 also includes a substep 340, in which an offset between P₂ and M₂ is computed, and a substep 360, in which the offset is processed in a low pass filter to form a smoothed offset O₂ between P₂ and M₂ (referred in FIG. 3 and subsequently as the “smoothed P₂ offset”). Using subscript “i” to designate the measurements at a specific measurement epoch, the low pass filter in substep 350 or 360 forms the smoothed P₁ or P₂ offset by sequentially averaging the offset according to the following equation:
O_{λ,i}=O_{λ,i-1}+(P_{λ,i}−M_{λ,i}−O_{λ,i-1})/n (7)
where λ=1 or 2 for designating the L1 or L2 frequency, and O_{λ,1} represents the smoothed P₁ or P₂ offset at the i^{th} measurement epoch. The low pass filter in substep 350 or 370 forms sequential averages until a maximum averaging interval is achieved and then it converts to an exponential smoothing filter. So, n equals to i until the maximum averaging interval is reached and then holds at that maximum value afterwards. It should be noted that other forms of low-pass filtering could be used. One alternative is to model the multipath errors in the code measurements as correlated noise and use a stochastic model of the multipath error in a Kalman filter to obtain an estimated offset between the code and carrier-phase measurements.

Step 210 in the process 200 further includes substeps 370 and 380, in which the smoothed P₁ and P₂ are each formed by summing the corresponding offset with the corresponding carrier-phase measurement, as in the following:
S_{λ}=O_{λ}+M_{λ} (8)
where S_{λ}, λ=1 or 2, represents the smoothed P₁ or P₂ code measurements.

It is noted that the values of the smoothed P₁ and P₂ offsets will approach specific values as the number of measurement epochs used in the smoothing process (referred herein also as the “averaging interval” or “smoothing count”) increases. Specifically, when enough averaging has been performed, the following should hold,
O₁=(K₁+K₂)ΔN₁λ₁−2K₂ΔN₂λ₂ (9)
O₂=2K₁ΔN₁λ₁−(K₁+K₂)ΔN₂λ₂ (10)
where the values of ΔN₁ and ΔN₂ represent the errors in the initial assignment N₁⁰ and N₂⁰ of the integer ambiguities in the raw carrier-phase measurements φ₁ and φ₂, respectively. For subsequent use, step 210 further includes a substep 390 in which the difference between the two smoothed offsets are computed to yield an estimated ΔN₁λ₁−ΔN₂λ₂:
O₂−O₁=ΔN₁λ₁−ΔN₂λ₂ (11)

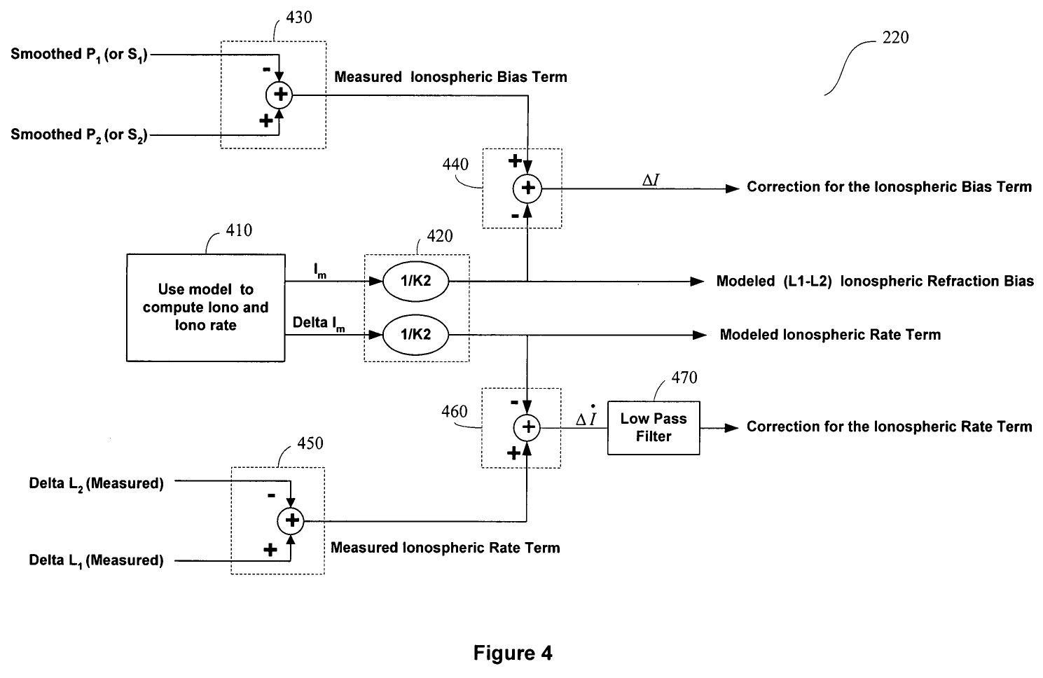

FIG. 4 is a flowchart illustrating in more detail the processing for generating ionospheric refraction corrections in step 220 in process 200. The ionospheric refraction corrections generated in step 220 are to be used to synthesize L2 measurements when direct L2 measurements are not available. As shown in FIG. 4, step 220 includes a substep 410, in which an ionospheric model is used to compute a modeled ionospheric bias term, Iₘ, and optionally a modeled ionospheric rate term, Delta Iₘ. The ionospheric rate term is computed from sequential differences of the ionospheric bias terms obtained from the model. Any of several ionospheric models could be used in substep 410, including the ionospheric model in the Wide Area Augmentation System (WAAS), whose corrections are broadcast from the WAAS communication satellites, the real-time ionospheric model used by the International GPS Service (IGS), and the ionospheric model whose corrections are broadcast from the GPS satellites. Since most ionospheric models generate the ionospheric refraction bias term and rate term in the P₁ code measurement at the f₁ frequency, the modeled bias term and rate term need to be divided by the K₂ coefficient to obtain the expected difference between ionospheric delays in the P₁ and P₂ code measurements. Thus, step 200 further includes a substep 420, in which Iₘ and Delta Iₘ are divided by K₂ for subsequent use.

Step 220 in process 200 further includes a substep 430, in which the smoothed code measurements computed in step 210 according to Equations (1) through (8) are differenced to yield a measured ionospheric bias term, and a substep 440, in which Iₘ/K₂ is subtracted from the measured ionospheric bias term to produce a correction, ΔI, to the modeled ionospheric bias term. Substeps 430 and 440 are performed according to the following equation:
ΔI=S₂−S₁−Iₘ/K₂ (12)

To generate an optional correction to the modeled ionospheric rate term, step 220 in process 200 further includes a substep 450, in which a difference between the L2 carrier-phase measurements taken at two consecutive measurement epochs (Delta L₂) is subtracted from a difference between the L1 carrier-phase measurements taken at the two consecutive measurement epochs (Delta L₁) to yield a measured ionospheric rate term. Substep 450 is followed by a substep 460, in which (Delta Iₘ)/K₂ is subtracted from the measured ionospheric rate term to produce a correction, Δ\dot{I}, to the ionospheric rate term. This ionospheric rate needs to be lightly filtered to provide some smoothing without excessive delay. Thus, step 220 in process 200 may further include a substep 470, in which the result from substep 460 is processed in a low-pass filter to produce a lightly filtered ionospheric rate correction. This lightly filtered value of ionospheric rate correction (filtering equation not shown) is used subsequently in equation (15) below. By differencing the measured ionospheric values from the modeled values, it should be possible to generate valid estimates of the ionospheric effect for longer time intervals since a major portion of the ionospheric dynamics is handled by the model. In equation form, steps 450 to 460 can be represented by:
Δ\dot{I}=(L_{1,i}−L_{1,i-1})−(L_{2,i}−L_{2,i-1})−(I_{m,i}−I_{m,i-1})/K₂ (13)
where subscript i designates the current measurement epoch, and subscript i-1 designates the measurement epoch prior to the current measurement epoch.

Steps 210 and 220 in process 200, in which values such as the smoothed code measurements and the corrections to the ionospheric bias term and the optional rate term are generated, are performed when measurements from both frequencies are available. Given that a sufficient interval of smoothing has occurred in the initial processing such that the values generated in steps 210 and 220 have most of the code multipath noise smoothed out by averaging, these values can be used to generate synthesized f₂ measurements in steps 230 through 250 when measurements on the f₂ frequency are unavailable.

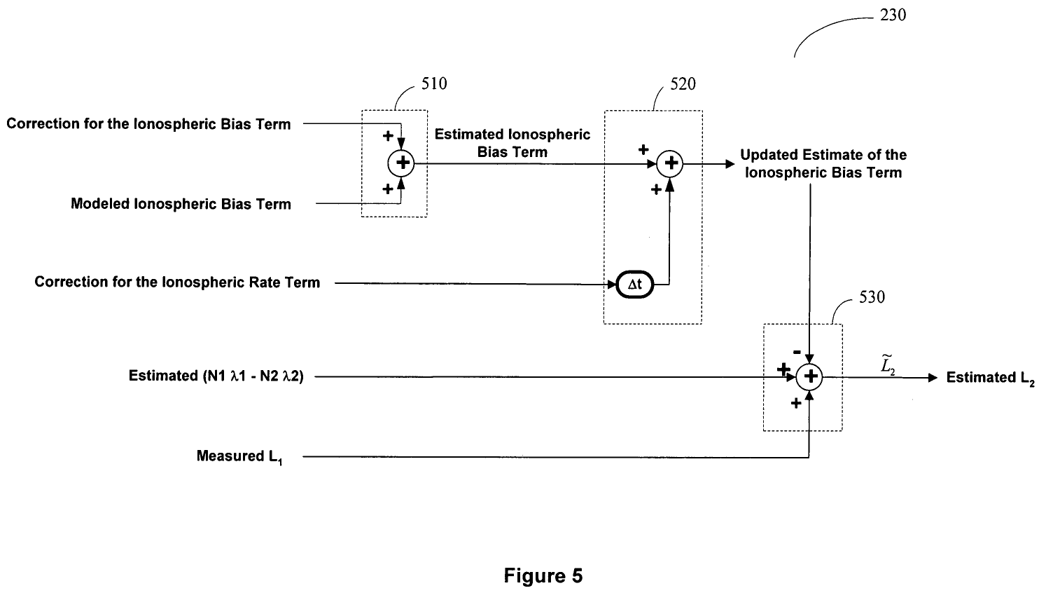

FIG. 5 illustrates a process flow in step 230, in which the L2 carrier-phase measurement is synthesized when direct measurements on the f₂ frequency are unavailable. As shown in FIG. 5, step 230 in process 200 includes an optional substep 510, in which the correction for the ionospheric bias term generated in the previous measurement epoch and the modeled ionospheric bias term generated in the current measurement epoch are summed to produce an estimated ionospheric bias term,

$${I}_{Estimate}^{Bias} .$$

Step 230 further includes an optional substep 520, in which the correction to the ionospheric rate term generated while the L2 measurements were available is multiplied by the time period Δt since the L2 measurements became unavailable and the product of the multiplication is added to the estimated ionospheric bias term to produce an updated estimate of the ionospheric bias term

$${I}_{Update}^{Bias} .$$

Step 230 further includes a substep 530, in which the updated estimate of the ionospheric bias term is subtracted from a sum of the L1 carrier-phase measurement at the present measurement epoch and the estimated ΔN₁λ₁−ΔN₂λ₂ to produce the synthesized L2 carrier-phase measurement \tilde{L}₂. In equation form, substeps 510, 520, and 530 can be described respectively by Equations (14), (15), and (16), as in the following:

$$\begin{matrix}{I}_{Estimate}^{Bias} = {I}_{m} / {K}_{2} + Δ I & ( 14 ) \\ {I}_{Update}^{Bias} = {I}_{Estimate}^{Bias} - {Δ IΔ t}^{• .} & ( 15 ) \\ {\tilde{L}}_{2} = {L}_{1} + ( Δ {N}_{2} {λ}_{2} - Δ {N}_{1} {λ}_{1} ) - {I}_{Update}^{Bias} & ( 16 )\end{matrix}$$

where \tilde{L}₂ designates the synthesized L₂.

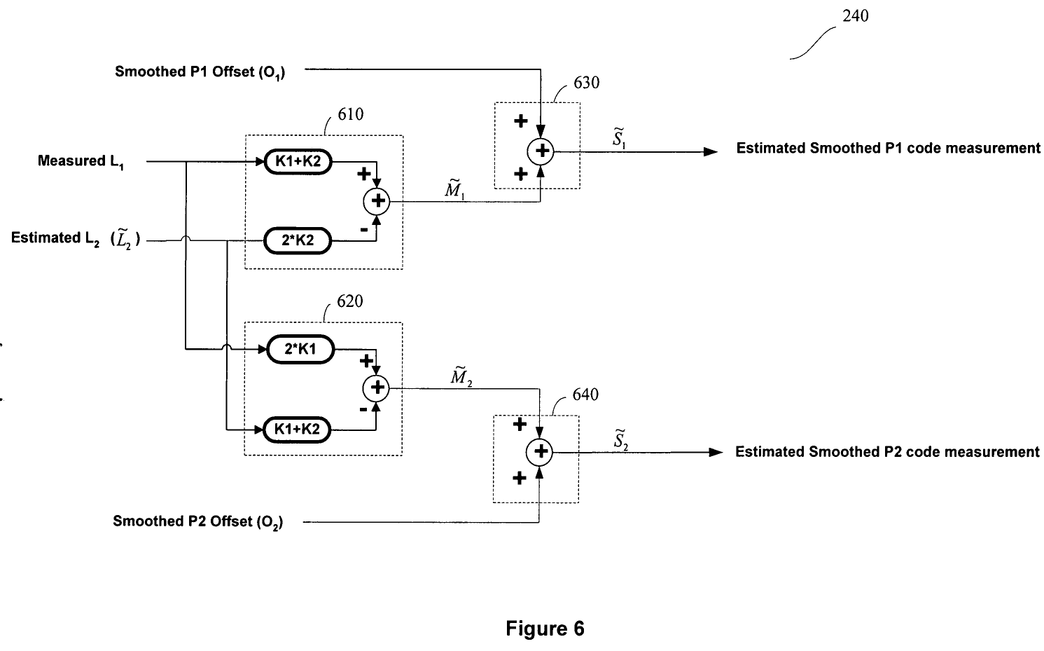

FIG. 6 is a flowchart illustrating in more detail the processing in step 240, in which the smoothed code measurements are synthesized from the L1 carrier-phase measurement and the synthesized L2 carrier-phase measurement. It might seem odd that the raw code measurement, P₁, is not used in synthesizing the smoothed code measurement at either frequency. Attempting to smooth the raw code measurement with the help of the synthesized L2 carrier-phase measurement would cause any errors in the modeled ionospheric refraction to generate biases that would be filtered into the offset values represented by equations (9), (10) and (11). To avoid creating an ionospheric refraction bias in the offset values, a process which is parallel to that shown in FIG. 1 is used, except that instead of an input of the code measurements and an output of the offsets, the offsets are input and the synthesized code measurements are output.

Accordingly, as shown in FIG. 5, step 240 includes a substep 610, in which the measured L1 measurement L₁ and the synthesized L2 measurement \tilde{L}₂ are combined to form a carrier-phase combination \tilde{M}₁ with an ionospheric delay that matches the ionospheric delay in the L1 code measurement P₁, and a substep 620 in which the measured L1 measurement L₁ and the synthesized L2 measurement \tilde{L}₂ are combined to form a carrier-phase combination \tilde{M}₂ with an ionospheric delay that would match the ionospheric delay in the undetected L2 code measurement. In equation form, substeps 610 and 620 can be expressed as:
\tilde{M}₁=(K₁+K₂)L₁−2K₂\tilde{L}₂ (17)
\tilde{M}₂=2K₁L₁−(K₁+K₂)\tilde{L}₂ (18)

Step 240 in process 200 further includes a substep 630, in which the smoothed P1 offset O₁ computed in step 210 is added to \tilde{M}₁, resulting in an estimated smoothed L1 code measurement \tilde{S}₁, and a substep 630 in which the smoothed P2 offset O₂ is added to \tilde{M}₂ resulting in an estimated smoothed L2 code measurement \tilde{S}₂, as expressed by the following equations:
\tilde{S}₁=\tilde{M}₁+O₁ (19)
\tilde{S}₂=\tilde{M}₂+O₂ (20)

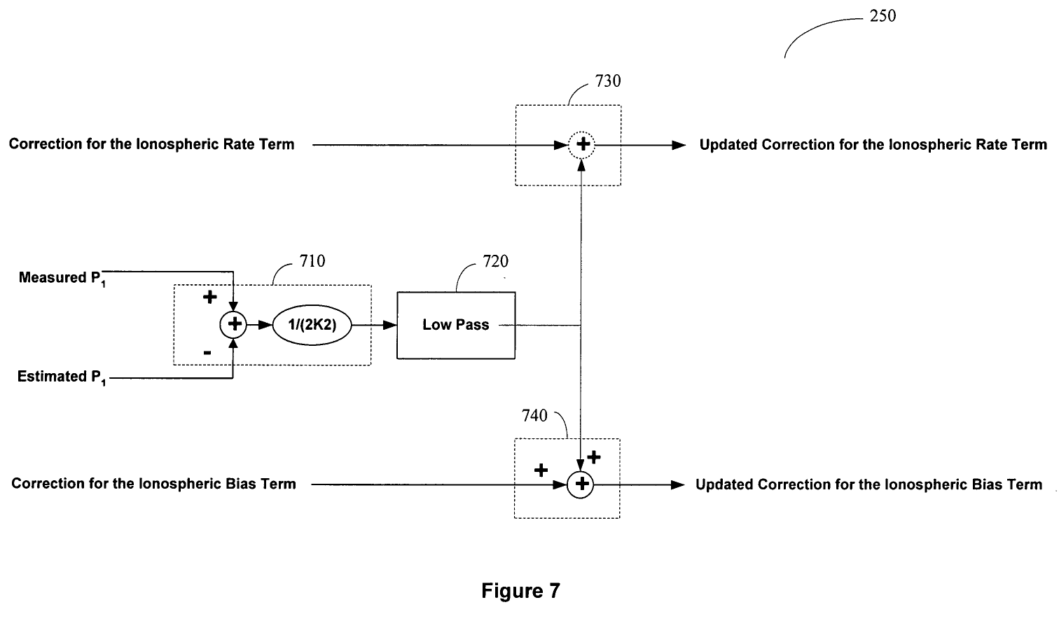

While the raw P₁ code measurement was not used to synthesize the smoothed code measurements, it can be used in the optional step 250 in process 200 to correct for small ionospheric refraction errors, which would otherwise accumulate. FIG. 7 is a flowchart illustrating in more detail the processing performed in the optional step 250 in process 200. Because the raw P₁ code measurement is noisy, it must be filtered heavily in a low-pass filter to avoid introducing more errors from the multipath effects than it removes from ionospheric refraction effects. Also, because the synthesized P₁ code measurement is generated from the L1 carrier-phase measurement, any error in the ionospheric model should affect the synthesized P₁ code measurement in a direction opposite to the way that error affects the raw P₁ code measurement.

Thus, step 250 includes a substep 710, in which the difference between the measured and synthesized code measurements is divided by 2K₂ to produce an ionospheric adjustment that scales with the ionospheric bias term and the optional rate term, and a substep 720, in which this ionospheric adjustment is smoothed in a low-pass filter to remove the multipath errors. Step 250 further includes an optional substep 730, in which the smoothed ionospheric adjustment is added to the correction to the ionospheric rate term to produce an updated correction to the optional ionospheric rate term, and a substep 740, in which the smoothed ionospheric adjustment is added to the correction to the optional ionospheric bias term to produce an updated correction to the ionospheric bias term.

It is also possible that a two-state estimator, e.g. an alpha-beta or Kalman filter, could be used to generate the updated correction to the ionospheric rate term. See Yang et al., “L1 Backup Navigation for Dual Frequency GPS Receiver,” Proceedings of the 16^{th} International Technical Meeting of the Satellite Division of the Institute of Navigation GPS/GNSS Conference, Sep. 9-12, 2003, Portland Oreg., which is incorporated herein by reference. By using some form of the process shown in FIG. 7, it may be possible to extend the time period that can be covered by the synthesis procedure in process 200.

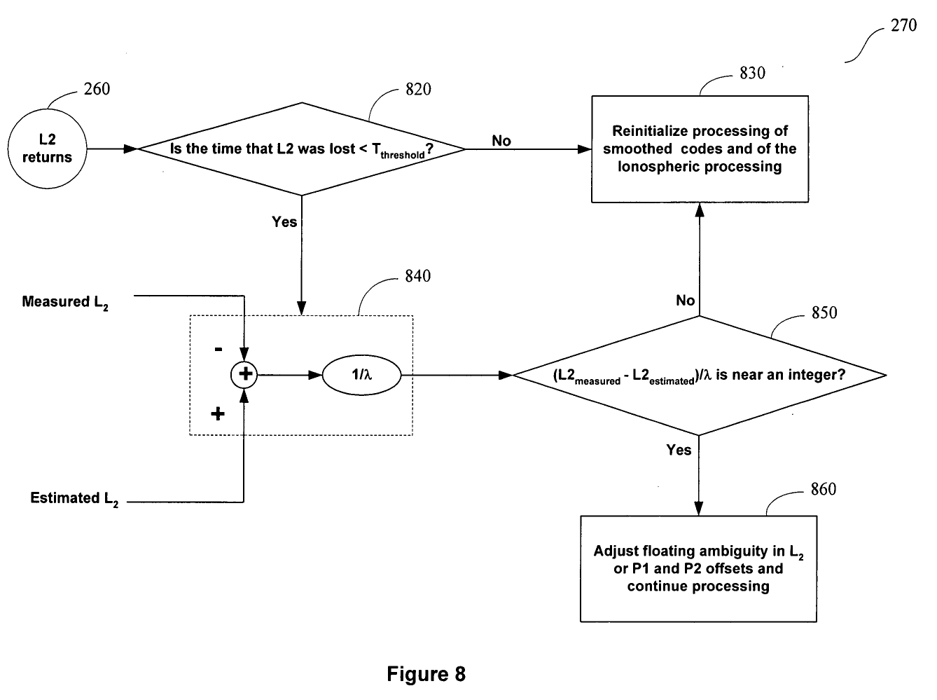

FIG. 8 is a flowchart illustrating in more detail the processing in step 270 in process 200, in which a transition to dual-frequency navigation is performed upon a determination in step 260 that the L2 signal has returned. Two tests are needed to determine whether or not the “floating integer” offsets computed in step 210 can be safely adjusted to avoid a reinitialization of the long smoothing process otherwise required. As shown in FIG. 8, the first test is performed in a substep 820, in which it is determined whether or not the interval of time Δt over which the L2 signal was lost exceeds a predetermined threshold. If the threshold is exceeded, then no adjustment is attempted and the smoothing process is reinitialized in a substep 830. Otherwise, the second test is performed in substeps 840 and 850, in which the difference between the measured and the synthesized or estimated L2 carrier-phase measurements is divided by the L2 wavelength to see if the result is close to an integer, i.e.:
(L₂−\tilde{L}₂)/λ₂≈integer (21)
If the result is not within some predetermined vicinity of an integer value, substep 830 is performed subsequently, in which the smoothing process is reinitialized. Otherwise, the result is used to adjust either the floating-ambiguity in the L2 carrier-phase measurement or the P2 code offset value so that the code smoothing process in step 210 can be resumed after this simple adjustment.

Because in practice the L1 signal is virtually never lost without a concomitant loss of the L2 signal, the technique described herein achieves its primary intended purpose when used to synthesize the L2 measurements from the L1 measurements during loss of only the L2 measurements. The present invention, however, can be applied to synthesize any of the L1 and L2 measurements, or measurements in some other frequency, such as the L5 frequency (equal to about 1.17645 GHz), by using measurements from another frequency that is not lost, with the help of a model of the ionospheric refraction effects, which is corrected by measurements taken while both frequencies are available.

1. In a system for navigating an object based on code and carrier-phase measurements obtained using signals on a first frequency and signals on a second frequency from a plurality of satellites, a method for continuing dual-frequency navigation in a situation where signals from a respective satellite on the first frequency are lost for a time period, the method comprising:
performing dual-frequency navigation before the time period, including computing smoothed code measurements and corrections to an ionospheric model based on code and carrier-phase measurements obtained using signals from the respective satellite on both the first and second frequencies;
performing backup navigation during the time period by synthesizing a carrier-phase measurement on the first frequency from a carrier-phase measurement on the second frequency and from the corrections to the ionospheric model computed prior to the time period; and
transitioning to dual-frequency navigation using signals from the respective satellite on both the first and second frequencies in response to resumption of receiving signals from the respective satellite on the first frequency.

2. The method of claim 1 wherein computing the smoothed code measurements comprises:
smoothing a code measurement with a combination of carrier-phase measurements, the combination having an ionospheric delay that matches an ionospheric delay in the code measurement.

3. The method of claim 1 wherein performing dual-frequency navigation further comprises:
obtaining a modeled ionospheric bias term computed using the ionospheric model;
computing a measured ionospheric bias term using the smoothed code measurements; and
computing a correction to the modeled ionospheric bias term by taking a difference between the measured and modeled ionospheric bias terms.

4. The method of claim 3 wherein performing dual-frequency navigation further comprises:
obtaining a modeled ionospheric rate term computed using the ionospheric model;
computing a measured ionospheric rate term using differences of carrier-phase measurements between two measurement epochs; and
computing a correction to the modeled ionospheric rate term by taking a difference between the measured and modeled ionospheric rate terms.

5. The method of claim 1 wherein performing backup navigation further comprises:
obtaining a modeled ionospheric bias term computed using the ionospheric model;
computing an estimated ionospheric bias term using the modeled ionospheric bias term and the corrections to the ionospheric model computed before the time period;
computing the synthesized carrier-phase measurement on the first frequency using the estimated ionospheric bias term and the carrier-phase measurement on the second frequency.

6. The method of claim 1 wherein performing backup navigation further comprises computing estimated smoothed code measurements on both the first and second frequencies using the synthesized carrier-phase measurement on the first frequency, the carrier-phase measurement on the second frequency, and computation results obtained based on signals from the respective satellite on both the first and second frequencies received at the object before the time period.

7. The method of claim 6 wherein performing backup navigation further comprises computing updated corrections to the ionospheric model based on the corrections to the ionospheric model, the estimated smoothed code measurement on the second frequency, and a code measurement obtained using signals on the second frequency.

8. The method of claim 1 wherein transitioning to dual-frequency navigation comprises:
determining whether the time period exceeds a predetermined threshold;
in response to a determination that the time period does not exceed a predetermined threshold, determining whether a difference between a measured carrier-phase range and a synthesized carrier-phase range corresponding to the first frequency is sufficiently close to an integer number of the wavelength corresponding to the first frequency; and
in response to a determination that the difference between the measured carrier-phase range and the synthesized carrier-phase range is sufficiently close to an integer number of the wavelength, adjusting an estimated ambiguity value associated with the measured carrier-phase measurement or adjusting an estimated offset between a code measurement on the first frequency and a carrier-phase combination having an ionospheric delay that matches the ionospheric delay in the code measurement.

9. In a system for navigating an object based on code and carrier-phase measurements obtained using signals from a plurality of satellites, a method for performing backup dual-frequency navigation when signals on one of two frequencies from one or more satellites are unavailable, comprising:
for each satellite from which signals on one of two frequencies are unavailable, generating a synthesized carrier-phase measurement on the one of the two frequencies from a measured carrier-phase measurement obtained using signals from the respective satellite on another one of the two frequencies, and from a first set of computation results obtained with respect to the respective satellite during steady-state processing when signals on both of the two frequencies were available from the respective satellite; and
generating smoothed code measurements on the two frequencies from the measured carrier-phase measurement, the synthesized carrier-phase measurement, and a second set of computation results obtained during steady-state processing when signals on both of the two frequencies were available from the respective satellite.

10. The method of claim 9 wherein the first set of computation results include corrections to an ionospheric model.

11. The method of claim 9, further comprising:
updating the corrections to the ionospheric model.

12. The method of claim 10 wherein the corrections to the ionospheric model include an ionospheric bias term and an ionospheric rate term.

13. The method of claim 10 wherein the first set of computation results include those computed from smoothed code measurements.

14. The method of claim 13 wherein the smoothed code measurements are computed by forming combinations of carrier-phase measurements each having an ionospheric delay that matches an ionospheric delay in a corresponding code measurement, and by smoothing the code measurement with the corresponding combination of carrier-phase measurements to remove multipath errors in the code measurement.

15. The method of claim 14 wherein the first set of computation results include those computed from smoothed offsets each between a smoothed code measurement and a carrier-phase combination corresponding to the code measurement.

16. The method of claim 15 wherein the second set of computation results include the smoothed offsets.

17. In a system for navigating an object based on code and carrier-phase measurements obtained using signals on a first frequency and signals on a second frequency from a plurality of satellites, a computer medium storing therein computer readable instructions that when executed by a computer performs a method for continuing dual-frequency navigation in a situation where signals from a respective satellite on the first frequency are lost for a time period, the instructions comprising:
instructions for performing dual-frequency navigation before the time period by computing smoothed code measurements and corrections to an ionospheric model based on code and carrier-phase measurements obtained using signals from the respective satellite on both the first and second frequencies before the time period;
instructions for performing backup navigation during the time period by synthesizing a carrier-phase measurement on the first frequency from a carrier-phase measurement on the second frequency and from the corrections to the ionospheric model computed prior to the time period; and
instructions for transitioning to dual-frequency navigation using signals from the respective satellite on both the first and second frequencies in response to resumption of receiving signals from the respective satellite on the first frequency.

18. The computer readable medium of claim 17 wherein the instructions for performing dual-frequency navigation further comprises:
instructions for smoothing a code measurement with a combination of carrier-phase measurements to form a smoothed code measurement, the combination having a ionospheric delay that matches an ionospheric delay in the code measurement; and
instructions for computing a correction to a modeled ionospheric bias term.

19. The computer readable medium of claim 17 wherein the instructions for performing backup navigation further comprises:
instructions for obtaining a modeled ionospheric bias term;
instructions for computing an estimated ionospheric bias term using the modeled ionospheric bias term and the corrections to the ionospheric model computed before the time period;
instructions for computing the synthesized carrier-phase measurement on the first frequency using the estimated ionospheric bias term and the carrier-phase measurement obtained using signals on the second frequency.

20. The computer readable medium of claim 17 wherein the instructions for transitioning to dual-frequency navigation comprises:
instructions for determining whether the time period exceeds a predetermined threshold;
instructions for determining, in response to a determination that the time period does not exceed a predetermined threshold, whether a difference between a measured carrier-phase range and a synthesized carrier-phase range corresponding to the first frequency is sufficiently close to an integer number of the wavelength corresponding to the first frequency; and
instructions for adjusting, in response to a determination that the difference between the measured carrier-phase range and the synthesized carrier-phase range is sufficiently close to an integer number of the wavelength, an estimated ambiguity value associated with the measured carrier-phase measurement or an estimated offset between a code measurement on the first frequency and a carrier-phase combination having an ionospheric delay that matches the ionospheric delay in the code measurement.
